(19) United States
(12) Patent Application Publication
(10) Pub. No.: US 2007/0195405 A1
(43) Pub. Date: Aug. 23, 2007

(54) Actively controlled night vision imaging system filter

(75) Inventors: Randy M. Maner, Albuquerque, NM (US); Teddy J. Wood, Corrales, NM (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/359,684

(22) Filed: Feb. 22, 2006

(51) Int. Cl. F21V 9/06

(52) U.S. Cl. 359/361; 359/350

(57) ABSTRACT

An optical filter and control system that provides graduated adjustment of the optical characteristics, which render a display compatible with the use of Night Vision Goggles. The control system enables real time adjustment of the filter's optical characteristics during operational use of the display. The filter is actively controlled to adjust its optical characteristics either by temperature adjustment and/or by physically altering the filter's angle of incidence relative to the observer or display illumination system. The characteristics are adjusted to achieve either better color rendering by the display or to achieve lower radiance within the NVG region of sensitivity. The active control system can either be adjusted by operator input or controlled by a built in algorithm, which is based upon operational conditions.

### BACKGROUND OF THE INVENTION

1. Field of the Invention (Technical Field)

The present invention relates to display systems and more particularly to optical filtering of backlights for transmissive displays, which are used in conjunction with Night Vision Imaging Systems (NVIS). In particular this invention is related to full color displays, which are required to be NVIS compliant per MIL-L-85762A or equivalently MIL-STD-3009.

2. Background Art

The optical requirements for an NVIS compliant full color display require the attenuation of some of the red spectral content of the display to eliminate interference with NVIS goggles, while simultaneously maintaining enough of the red energy to provide visible functionality of the display. An improvement in display performance is enabled by a controlled adjustment of the display optical characteristics dependent upon the user's current utilization of the display.

The problem addressed by the present invention occurs when a user of an NVIS compatible display, which is most typically an aircraft pilot using NVIS goggles to view things outside of the aircraft and consequently needs the display to permit the highest performance of the goggles. To provide the highest performance of the goggles the display should not emit any energy to which the goggles are sensitive (˜620 nm to 930 nm). Another requirement is to allow the pilot to glance under the goggles to view information on the cockpit displays, in particular viewing items depicted in red on the display. The pilot needs the red information to be relatively bright and easily distinguished from other colors on the display when directly viewing the display and yet needs it to be extinguished when looking through the goggles. So the problem is manifested by the pilot's needs to almost simultaneously view information through the goggles for a portion of their task and within a very short span of time switch to viewing the red information on the display.

This problem arises with the design of the NVIS filter, which has high visible spectrum transmission to achieve good visible performance and low red and near infrared spectrum transmission to achieve required NVIS performance. The NVIS filter design characteristic which establishes the balance between visible and NVIS performance is the display design element which controls the transition between these two different optical characteristics of the display.

In general, achieving NVIS radiance compromises the display's color saturation by limiting the amount of red spectral content. Consequently, the colors most significantly affected by the NVIS filter are the colors of red, white, or any secondary color using a significant amount of red. A typical means of evaluating the influence of the NVIS filter on the display color performance is to measure the difference in chromaticity coordinates between the NVIS filtered and unfiltered display. These chromaticity coordinates can be compared by determining the radial distance between them which is most useful when using coordinates specified on the Commision Internationale de I'Eclairage (CIE) 1976 Uniform Chromaticity Space (UCS) chromaticity diagram. FIG. 5 shows the change in red and white chromaticity for one particular display when the NVIS filters 50% transmission characteristic is changed. As the NVIS filter's 50% transmission point increases beyond 655 nm only a negligible color shift is imposed on the display's chromaticity, whereas filter characteristics at 635 nm induce a noticeable change in color performance of the display due to chromaticity shifts and a reduction in red luminance by approximately 20%. Both the reduction in saturation and luminance decrease the legibility of items displayed in red which are typically of critical importance in military display formats.

The effect on display performance achieved by changing the NVIS filter 100 characteristics is illustrated in FIGS. 4 and 5. A simple means of roughly identifying a particular NVIS filter's characteristic is to identify the wavelength at which 50% transmission occurs in the transition between the region of high transmission in the visible spectrum and high attenuation in the red/near infrared spectrum. FIG. 2 shows a reflective component with a 50% transmission at 665 nm at 0° angle of incidence which varies to 657 nm at 150 angle of incidence and 637 nm at 300 angle of incidence. FIG. 3 shows a NVIS filter with a 50% transmission at 668 nm at 23° C. decreasing to 658 nm at 80° C. FIG. 4 shows the effect on NVIS radiance for one particular display when the NVIS filter 50% transmission characteristic is changed. The variation from 657 nm to 637 nm causes NVIS radiance to change by approximately one order of magnitude which is a noticeable change in display performance.

The display performance as a function of NVIS filter temperature and position characteristics are used to establish critical parameters for the controlling algorithm used to make adjustments to the display performance based upon an external system's NVIS control input. The NVIS control input is some form of electrical communication information (e.g., serial or parallel digital, analog voltage, frequency, current, etc.) which correlates to the user's desired level of NVIS radiance or color saturation and luminance performance for the display.

The most common means of providing an NVIS compliant display is to filter the light source. This can be done by providing one light source which is always filtered or it can be done by a dual mode backlight with one mode containing NVIS filtered light and having the ability to switch between NVIS compatible lighting and non-compatible lighting. For these designs the characteristics of the NVIS filter are established at the time of design and are not adjusted during actual operation of the display.

U.S. Pat. No. 5,615,032 to Kalmanash, et al., describes an electronically controlled NVIS filter, which uses electrically, activated liquid crystal materials to switch the NVIS filter characteristics. This patent describes a die doped liquid crystal material to perform the function of filtering for night vision goggle applications. U.S. Pat. No. 6,574,030 to Mosier, describes an electrically controlled mirror that either directs the backlight illumination through an optical path with an NVIS filter or without depending upon the mode of operation. Both of these would allow the NVIS filter to be effectively switched into place, but they do not allow the user to adjust the graduated levels of NVIS radiance emitted by the display or adjust the amount of red color emitted by the display. So, in effect they would still have an NVIS filter characteristic that is fixed at the time of initial display design without any tuning ability during actual operation.

None of the prior art teaches an adjustment to alter the NVIS filter characteristics within a display as taught in the present invention. In the prior art systems the performance of the NVIS filtered light source is fixed in its spectral content and cannot be changed when in operational use. Therefore, the function of adjusting the amount of red or NVIS radiance across a gradient is not currently implemented in NVIS compatible display systems. By permitting real time adjustment of the display's NVIS filter characteristics the operator can adjust for either better color rendering capability or lower NVIS radiance depending upon his/her preference or operational need.

### SUMMARY OF THE INVENTION (DISCLOSURE OF THE INVENTION)

The novel concept of this invention is the ability to adjust or control the NVIS filter characteristics dependent upon the user's operational situation. This is accomplished by use of a thermal, mechanical or a combination of the two, control system to modify the NVIS characteristics. This control will also provide improved red performance of the display when it is of benefit to the display user. Further, this control function can be a user adjustment mechanism or automatically implemented through software or firmware algorithms. To achieve this NVIS or red control it is necessary to provide an NVIS filter whose optical characteristics can be modified during normal operation of the display. In this manner, adjustment of the optical characteristics can be implemented by thermal and/or mechanical adjustment of the NVIS filter. This permits improved legibility of information encoded in red symbology, which is typically of critical importance. It also permits improved night vision goggle performance when used in conjunction with the appropriately adjusted display device. This invention enables real time adjustment specific to a particular operator's desired display characteristic.

A primary object of the present invention is to provide a control to adjust the NVIS radiance characteristics of an electronic display.

A primary advantage of the present invention is that it provides adjustable NVIS compatible performance for a display, which allows operator selection of the magnitude of red luminance and NVIS radiance emitted from the display.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows the preferred embodiment of the invention.

FIG. 2 is a graph showing a reflective component with a 50% transmission at 665 nm at 0° angle of incidence which varies to 657 nm at 150 angle of incidence and 637 nm at 30° angle of incidence.

FIG. 3 is a graph showing a NVIS filter with a 50% transmission at 668 nm at 23° C. decreasing to 658 nm at 80° C.

FIG. 4 is a graph showing the effect on NVIS radiance for one particular display when the NVIS filter 50% transmission characteristic is changed.

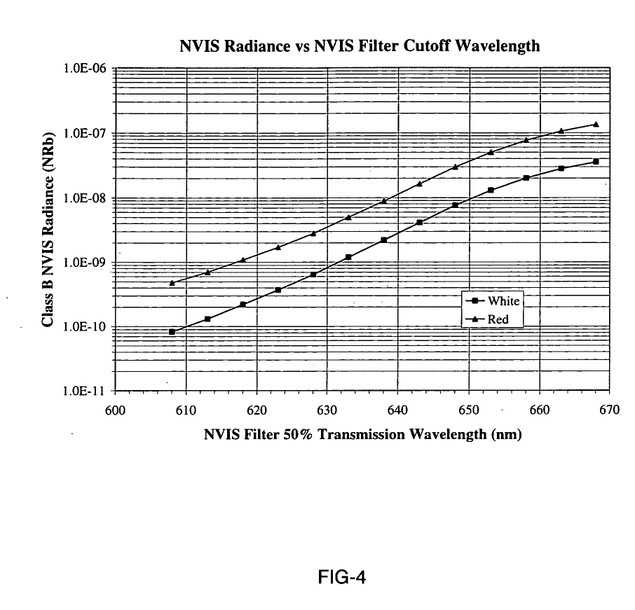

FIG. 5 shows the change in red and white chromaticity for one particular display when the NVIS filter's 50% transmission characteristic is changed.

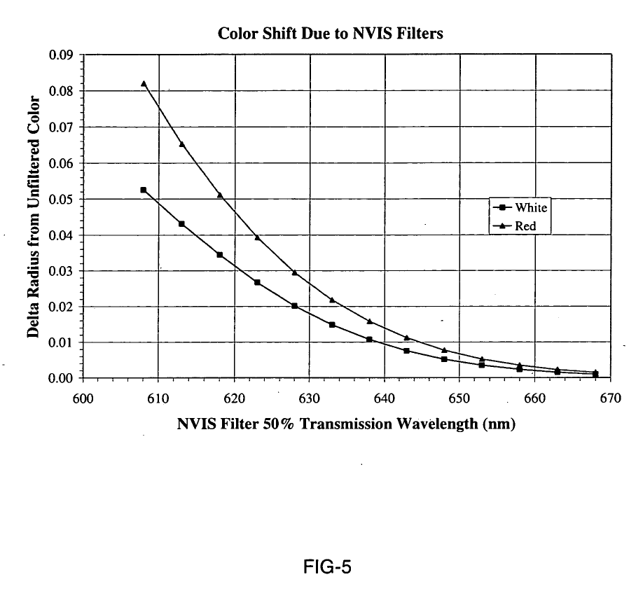

### DESCRIPTION OF THE PREFERRED EMBODIMENTS (BEST MODES FOR CARRYING OUT THE INVENTION)

The present invention provides the means for controlled adjustment of the NVIS filter characteristics by either mechanically adjusting the filter, for example tilting the filter or moving the filter out of the optical path or heating and cooling the filter to provide real time adjustment of the optical performance.

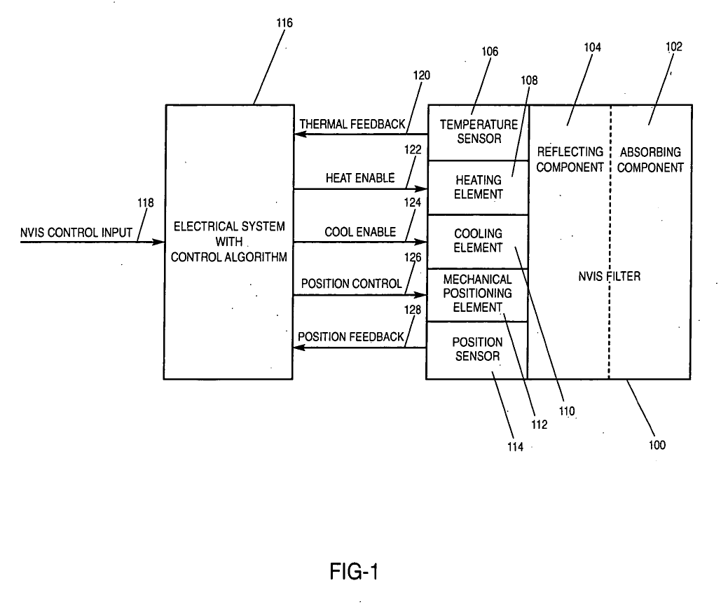

As shown in FIG. 1, a NVIS filter 100 for full color displays is typically constructed from two primary optical components, a near infrared absorptive component 102 and a near infrared reflective component 104. These two components may be constructed on two separate optical substrates and physically bonded together before inserting them into the display system or they may be constructed on a single substrate, which is installed into the display system.

The first component, near infrared absorptive component 102, provides high transmission in the visible spectrum (˜400-650 nm) and absorbs radiation in the spectral region of the Night Vision Goggle (NVG) sensitivity (˜620-930 nm). Typically the transition from high to low spectral transmission of the near infrared absorptive component is a gradual characteristic which occurs over a few hundred nanometers. The near infrared absorptive filter is typically constructed with glass similar to Schott Glass Technologies KG3 or Kopp Glass 7093 or Wamco BM-02. Hoffman Engineering, Korry Electronics, Dontech and Wamco also offer plastic products which have similar optical characteristics, which can also be used for this first component of NVIS filter 100.

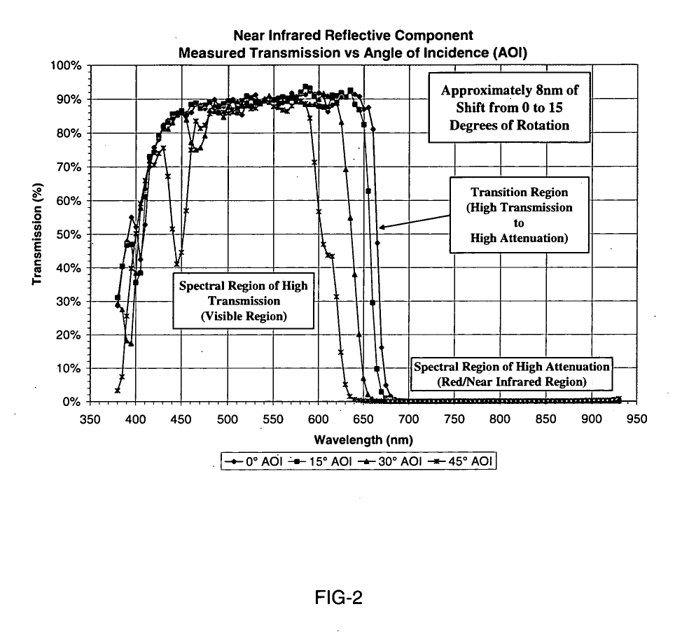

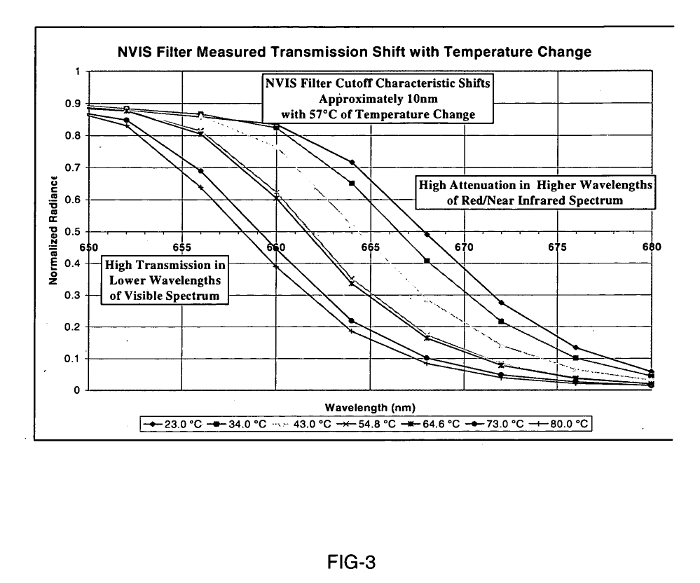

The second component of NVIS filter 100 is near infrared reflective component 104, which provides high transmission in the visible portion of the spectrum with a sharp transition to high reflection in the NVG sensitive portion of the spectrum. Typically the transition from high to low spectral transmission of the near infrared reflective component is a very sharp change which occurs over 10 to 20 nanometers. Near infrared reflective component 104 is typically an interference filter constructed with thin film coatings, which are deposited by common well known means (e.g., sputtering or evaporation). To achieve the necessary optical characteristics, the composition requires depositing many layers of alternating high and low index of refraction materials of various thicknesses to fabricate near infrared reflective component 104. For this type of filter/component, the forward transmission characteristics are highly dependent upon the angle of incidence of radiation passing through the filter. Light rays passing through the optical filter along the filter's surface normal have a different optical path length than those passing through at a higher angle of incidence which causes the spectral characteristics of the transmitted illumination to vary. The transmissive and reflective characteristics are effectively shifted to lower wavelengths for higher angles of incidence, which most noticeably affect the sharp transition distinguishing the high transmission and attenuation regions as shown in FIG. 2. The most amount of red energy is transmitted through the filter at the lowest angle of incidence which corresponds to the best red color performance and worst NVIS radiance performance for the display incorporating this filter. Conversely, worse red color performance and better NVIS radiance performance is achieved with the higher angles of incidence through reflective component 104. A similar optical effect can be obtained by heating or cooling the thin film coating causing it to expand or contract which causes a corresponding increase or decrease in optical path length and the resultant shift in transmission and reflection characteristics. This change is depicted in the measured transmission characteristics shown in FIG. 3. The most amount of red energy is transmitted through the filter at the lowest temperature which corresponds to the best red color performance and worst NVIS radiance performance for the display incorporating this filter. Conversely, worse red color performance and better NVIS radiance performance is achieved with the higher temperatures of reflective component 104. A combination of the angular position and temperature can also be used if both mechanisms are designed into the system which would provide an even wider range of adjustment.

The present invention utilizes the changes in the near infrared reflective component 104 characteristic as shown in FIGS. 2 and 3. The design and manufacturing method used to create the optical filter can enhance these characteristics for either the angular or temperature dependence. By decreasing the density of the coating, the sensitivity to temperature is increased and by increasing the number of optical layers to create the coating, the changes across angle can be increased.

Referring again to FIG. 1, to achieve the optical characteristic shifts thermally, it is necessary to provide a method of heating using a heating element 108, and cooling using a cooling element 110 for NVIS filter 100, and it is also desirable to know the temperature using a temperature sensor 106 so that a closed loop control system via thermal feedback 120, heat enable 122, cool enable 124, can be implemented to adjust the optical characteristics. To achieve this any one of many various methods of heating can be implemented. One method is to deposit a transparent layer of Indium Tin Oxide (ITO) resistive coating across a surface of NVIS filter 100 with low impedance conductive strips along two edges to form a resistive electrical heating element (not shown). This type of heating element is commonly used to heat up optical elements like Active Matrix Liquid Crystal Displays (AMLCDs) for cold temperature operation. Another method for heating is to provide an electrical heating element which is used to secure the edges of NVIS filter 100 (not shown). Another method to heat NVIS filter 100 is to vent hot air directly on NVIS filter or through the thermally conductive mechanical mounting features holding NVIS filter 100 through an electrically controlled valve (not shown). Any one of many various means of cooling NVIS filter 100 can be implemented. One means is to vent cool air either directly onto NVIS filter 100 or through the mechanical mounting features holding NVIS filter 100 through an electrically controlled valve. Another method of heating and cooling is to mount the edges of NVIS filter 100 into a highly thermally conductive frame which is thermally controlled by a thermal electric cooler (not shown). Use of a temperature sensor 106 is desired to provide thermal feedback 120 to provide a heat enable 122 signal for properly controlling the heating and a cool enable 124 signal for properly controlling the cooling of NVIS filter 100. Temperature sensor 106 can be a separate device such as a thermistor, thermally bonded to NVIS filter 100 or it can be fabricated onto the optical filter in the form of thermally variable diodes or a resistive coating which changes in a known manner as a function of temperature. All of these types of heating, cooling, and temperature sensing elements are well known in the art and the present invention uses the combination of these common elements along with the changing optical characteristics of the NVIS filter to create the unique elements of the invention.

Typically an NVIS filter 100 is secured into the display or backlight system in a fixed position. In one configuration it may be advantageous to fix NVIS filter 100 at a particular angle relative to the user and leave it permanently in that orientation. For this fixed mechanical orientation configuration only adjustment of the temperature can be used to actively alter the NVIS filter 100 characteristics. However, by securing the NVIS filter on a mechanical positioning element 112 which enables tilting NVIS filter 100 relative to the viewer's position; adjustment of the optical characteristics as seen by the user can be changed in a controlled manner. To achieve better color performance the filter can be adjusted such that the filter's surface normal is aligned directly with the user's viewing angle, and to achieve lower NVIS radiance the filter can be adjusted at a high angle of incidence relative to the user's viewing angle. For another method of adjustment, the filter can be allowed to move completely out of the optical path of the viewer, which maximizes color performance of the display while providing little to no attenuation needed for NVIS performance, this can be accomplished with a mechanism similar to a Venetian blind or an optical shutter. Mechanical positioning can also be accomplished by any one of many various means such as an indexed motor or screw driven adjustment. The range and resolution of mechanical motion is only limited by the mechanical and optical design constraints of the display system. A positional sensor 114 can be incorporated with the use of a hall sensor or equivalent device which can be positioned adjacent to the filter or can be built into the positioning motor. This embodiment can include a positional control 126 to adjust the position of NVIS filter 100 and can incorporate positional feedback 128 from positional sensor 114 to optimize mechanical positioning element 112.

An electrical system with controlling algorithm 116 is used to enable and disable the various elements affecting the NVIS filter 100 characteristics. Using feedback from temperature sensor 106, the electrical system controlling algorithm 116 enables and disables the heating 108 and cooling 110 elements of NVIS filter 100 to achieve a desired temperature. A similar situation exists for the mechanical positioning element 112 which is also positioned in a particular orientation as commanded by the electrical system with controlling algorithm 116.

The information provided by the NVIS control input signals 118 is used by the electrical system with controlling algorithm 116 to establish the desired conditions of NVIS filter 100 in terms of temperature and orientation. When NVIS control input signals 118 indicate the display is in day mode or normal mode of operation then actions are taken to provide the best color and luminance performance for the display. In these conditions NVIS filter 100 is cooled to room temperature or below. Depending upon the mechanical system configuration, NVIS filter 100 is either adjusted to have the filter's surface normally pointed directly at the user or it is moved completely out of view. When NVIS control input signals 118 indicate the display is in NVIS mode and there is a need to be looking through the NVIS goggles, the filter is heated up to ˜85° C. NVIS filter 100 can also be adjusted in orientation to increase the angle between the NVIS filter surface normal and the line of sight of the user to further extinguish the near infrared and red spectrum to which the NVIS goggle is sensitive.

To provide real time or manual adjustment NVIS control input signal 118 can be attached to a potentiometer that the pilot can adjust to determine if there is a desire for better NVIS or better visible spectrum performance.

Although this disclosure discusses using both the temperature control and mechanical orientation, these systems can be used individually. For example, one system can have a fixed mechanical orientation of the NVIS filter and use only the temperature control to adjust the NVIS filter characteristics. The second system can only make mechanical adjustments while not providing the ability to adjust the temperature of the NVIS filter.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. An optical filter for rendering displays compatible with night vision imaging systems comprising:
at least one coated optical substrate; and
a means for controlling a transmissive characteristic of said at least one coated optical substrate.

2. The optical filter of claim 1 wherein said at least one coated substrate comprises a near infrared absorptive component and a near infrared reflective component.

3. The optical filter of claim 1 wherein said means of controlling a transmissive characteristic of said at least one coated optical substrate comprises a thermal controlling structure.

4. The optical filter of claim 3 further comprising a temperature sensor with feedback.

5. The optical filter of claim 1 wherein said means of controlling a transmissive characteristic of said at least one coated optical substrate comprises a mechanical positional controlling structure.

6. The optical filter of claim 5 further comprising a positional sensor with feedback.

7. The optical controller of claim 5 wherein said mechanical positional controlling structure comprises an apparatus for moving the at least one coated optical surface from a viewing angle.

8. The optical filter of claim 1 wherein said means of controlling a transmissive characteristic of said at least one coated optical substrate comprises a thermal controlling structure and a mechanical positional controlling structure.

9. The optical filter of claim 1 wherein said means of controlling a transmissive characteristic comprises a manual controller.

10. The optical filter of claim 1 wherein said means of controlling a transmissive characteristic comprises an automatic controller.

11. The optical filter of claim 1 wherein the means for controlling a transmissive characteristic comprises a combination manual and automatic controller.

12. A method for optically filtering displays compatible with night vision imaging systems, the method comprising the steps of:
a) providing at least one coated optical substrate; and
b) controlling a transmissive characteristic of the at least one coated optical substrate.

13. The method of claim 12 wherein the step of providing at least one coated substrate comprises providing a near infrared absorptive component and a near infrared reflective component.

14. The method of claim 12 wherein the step of controlling a transmissive characteristic of the at least one coated optical substrate comprises controlling a temperature of the at least one coated optical surface.

15. The method of claim 12 wherein the step of controlling a transmissive characteristic of the at least one coated optical substrate comprises controlling a position of the at least one coated optical surface.

16. The method of claim 15 wherein the step of controlling a position comprises moving the at least one coated optical surface from a viewing angle.

17. The method of claim 12 wherein the step of controlling a transmissive characteristic of the at least one coated optical substrate comprises controlling a temperature and controlling a position of the at least one coated optical surface.

18. The optical filter of claim 12 wherein the step of controlling a transmissive characteristic comprises manually controlling.

19. The optical filter of claim 12 wherein the step of controlling a transmissive characteristic comprises automatically controlling.
